(19) United States
(12) Patent Application Publication
(10) Pub. No.: US 2010/0269477 A1
(43) Pub. Date: Oct. 28, 2010

(54) MANUAL HARVEST SYSTEM FOR FINE WINE GRAPES CROP

(76) Inventor: Ramiro Ivan CORNEJO ROJAS, Santiago (CL)

Correspondence Address: Hasse & Nesbitt LLC, 8837 Chapel Square Drive, Suite C, CINCINNATI, OH, 45249, US

(21) Appl. No.: 12/428,939

(22) Filed: Apr. 23, 2009

(51) Int. Cl. A01D 46/00

(52) U.S. Cl. 56/328.1

(57) ABSTRACT

Manual grape harvesting system for fine wines production, which improve the laborers conditions avoiding the lumbar lesions and possible accidents caused by working tools, the system comprising: a) a constriction lumbar belt with length adapting means and lumbar straightening means; b) a frontal modular piece with closing means, accessories store means and adjust belt means to constraint the laborer lumbar back area; c) a curved container to store the grape bunches, temporally fixed to the frontal modular piece through said belt adjust means

The present invention is related to a manual harvest system for fine wine grapes crop, which principal objective is to prevent the lumbar lesions in the laborer column; furthermore objective of the present invention is to provide a suitable equipment for the storage of the picked grapes bunches and provide secured means to storage the tools and accessories used in the harvest work.

### BACKGROUND OF THE INVENTION

In manual grape harvesting work, generally the laborers use scissors to cut the bunch stem and additionally they carry on a container to deposit the cut grape bunches, while they go between the grapevines the container is dragged by the laborer to the working zone.

Some solutions are being developed, generally are solutions obtained by the same laborers and its consist of attach one or a pair of belts to hang the container from their shoulders and keep it next to their bodies and in upping position while they go advancing through the grapevines rows, with this solutions the laborers do not need to crouch down each time they cut out a bunch.

Furthermore, the laborers use little cases to protect themselves from the scissors harms. Usually those cases are hooked to the pants belt or inserted in the pockets.

There are another solutions like pick up bags hanging with harness around the shoulders, where those bags has an opened base temporally closed to unload the fruits collected pouring it in the mean vessel.

Another solution for harvesting work are related with harvesting machines, but in those situations the laborer does not take part in the cut process, they only drive the machines, where those machines go through the grapevines row equipped with cutting devices which cut out the bunches and are received in big vessels.

This industrialized technique is suitable for huge production, but it is not suitable for little producers or productions of grapes for fine wine, so that the fine wine needs grapes in perfect state, with non damage that produce fermentation in the grapes.

The physic work conditions for the laborers used to be insufficient, they do not count on with suitable equipment to work in safe conditions, often they suffer a lot of lumbar lesions caused by the height load they have to lift to pouring the picked bunches to the collecting container or caused by the repetitive crouch movement to deposit the picked bunches in the little container.

The present invention aboard said problems with a suitable harvesting equipment that avoid the lumbar lesions in the laborer's back through the provision of a curved picking container attached around the body and specifically attached to a special belt which constrains the lumbar area.

### SUMMARY OF THE INVENTION

The manual harvest of grapes for fine wine production aims to obtain grapes with any damage, because any damage produces the undesirable fermentation, so the manual harvest consist in the cut of the grapes bunches without machines, except by a manual scissor to cut the bunch stem operated by a laborer.

The grapevines row has no more than 130 to 150 centimeters of high and the laborer advance between the row cutting the grape bunches with a scissor and deposits the bunches in a container.

When the container is full of bunches, the laborer carry on it to the storing area, where those bunches are carefully deposited in special trays, so that bunches are distributed to avoid the damage between them. The laborer win a coin for each filled container and that coin will be changed for real money when their work is done.

The different action of the laborer during his work are centered principally in manipulate the scissors, extracting it and keeping it inside his pocket or a case hanging from the belt, he needs to carry on the grape container and to keep the coins he won.

All said activities implies important impacts to the laborer body and several studies are demonstrated an increasingly incidence of lumbar lesions in this group of laborers, caused specially by the high load of the containers lifted.

The lumbar lesions usually presented by this kind of laborer are lesions in the intervertebral discs, exactly in the lumbar region of the column and these are caused by the repetitive lift movements to pour the fruits picking container. Often, people do not know the right way to lift a load with the arms, because they lift the load without folding the legs and all the force is made with the arms and back. The right way to lift a load is try to put the load very close to the body, then fold the legs, embrace the load next to the chest or stomach and then stand up transferring all the force to the legs and not to the back or the arms.

The lumbar area of the column is affected too by the wrong way of transport a load, carrying it on in the arms but not enough close the central axis of the body. This wrong way, when it turns repetitive, could cause lumbar damage, too.

This kind of column pathologies are the principal cause of worker diseases, specifically in vintage laborers, but in second place, they present some wounds caused by scissors during cutting work and when its kept in pockets.

The present invention propose an harvesting system to manual grape crop for produce fine wines, which improve the laborers conditions avoiding the lumbar lesions and possible accidents caused by working tools.

The present invention provides an equipment formed by a lumbar constrictor belt, which has means to adjust its length to a body laborer perimeter and also has means to support a container with special shape to deposit the picked grapes bunches.

Said special container shape consists in a circular arc which fits against the user's stomach contour, maintaining the load container next to the vertical axis body, furthermore the invention provides safety storing areas for scissors and storing areas for coins won.

The manual harvesting equipment is formed for the following parts: a constrictor lumbar belt, a frontal modular piece which is constructed in a rigid material and has multiple functions and a circular arc shape container where cut grape bunches are deposited.

The constriction lumbar belt consists in a flexible member constructed in a elastic and cushioned material, preferably woven low elasticity Nylon, which it wraps around the body contour in the lumbar area of the user. Said constriction belt is provided with a pair of rigid cushion members disposed one to each side of the user's column.

Said cushioned members are provided with an internal and straightening rib slightly flexible, disposed in the core. This piece allows an improved straightness of the user's lumbar area, especially when the user exerts the mayor force in their work.

The constriction lumbar belt constraints the user's perimeter, modifying its working positions, forcing the user to get a suitable back position through the abdominal constriction and lumbar cushion members.

The constriction belt has an irregular shape, presenting a greater width in the back area of the belt, decreasing its width toward the lateral areas of the belt to facilitate the lateral body flexions of the user. Both ends of the belt are free but are adjustable, and are provided with removable fastening means, like Velcro patches.

Said Velcro patches, allows the adjustable perimeter length once the belt ends has been passing through a passing groove present in the modular frontal piece.

The frontal modular piece is constructed in a rigid material by two independent modulus, exhibiting a curve shape, both. Said curve shape responds to an adaptation to the rounded shape of the laborer's body. The modulus piece is a multifunctional piece, so it has closing means for the constrictor belt, a length adjust mean for the constrictor belt, means for tight the belt around the laborer's body, store means for accessories and support means for the curve container.

Said closing means consists of a mechanical tie closure with automatic release means activated by a push button; in a preferred embodiment said close mean consist of one or more grooved stems rising in a lateral face of one of the modular piece which are faced to a circular perforation presented in the opposite modulus, said perforations are temporarily covered by a cylindrical retractile piece, which is connected to a base coil and at the same time said cylindrical piece is activated by said push button. In operation, said push button moves down the cylinder uncovering the circular perforations to allow the stem entrance, so said grooved stems are trapped in the perforation by the retractile cylinder.

Said length adjust mean for the constrictor belt consists in a channel disposed in the modulus and connected to a interior axis, so the belt enter and exit by said channel resulting engaged around said axis. When the free end of the belt exits the channel, this extreme could be adhered to itself by Velcro permitting adjusts the belt length to the user perimeter body.

Said belt constriction mean is a mechanism formed by two external levers with “L” shape, attached to the modulus by the horizontal stem of the “L” shape element, while the vertical stem is disposed relative to the horizontal stem in a angle superior than 90° degrees.

Said levers has two functional positions: the first one in an inoperative situation, rests folded over the modulus and the second one in an operative situation, unfolded toward to an exterior position. Said levers are attached in the modulus interior to said internal axis, which axis has an eccentric position where the belt is wrapped around to engage it before exits from the modulus and then to fix to itself by the Velcro patch.

The movement mechanism of the “L” levers is activated ones a time the constriction belt has been closed and the free ends of the belt has been fixed to it self, and it consists in a hand operation unfolding from the first position to the second one. This unfolding movement, actives internally the eccentric axis to a closer position between both axis, throwing the belt engaged around it causing a contrite of the belt around the body's perimeter.

The accessories store means of the frontal modulus consists of pockets partially closed, constructed with a flexible material, like rubber, with a conical inverted shape and a elliptic cross section, which superior face is opened by a slot. These flexible pockets are destined to contain accessories like scissors or coins.

The flexible material of the pockets is preferably an elastic material and its allows that the superior slot could open wide to receive the stuffs and turn back immediately to the original closed position, preventing the stuffs falls down from the pocket and, at the same time, it allows a simply access of the fingers laborer into the pocket.

Said pockets are independent from the frontal modulus, but are retained in it, specifically inside a cavity disposed in each modulus, which said cavities are suited to receive the pockets by a conical shape homologous with the conical pocket shape. And to facilitate the pocket grip from the cavities, these cavities have a frontal groove where a few part of the pockets are exposed.

In a preferred embodiment, the frontal wall of the pockets has a little depression to let the user's fingers could grip the pocket to thrown up from the frontal modulus.

Said accessories pockets allows to store the scissors in a safety way, so the laborer are protected from damage caused by the wrong store means like holding it in the hands or storing it inside the pants pockets.

The support means of the curved container consist of the same “L” shaped levers disclosed before, so when they are-in an operative spread position they are used like support arms to receive the curved container.

The inferior flag of the “L” lever has a length related to the width of the base wall of the curved container, while the vertical flag high of the “L” lever is related to the vertical walls of the curved container.

The grape bunches curved container is a vessel opened to the top, made of a polymeric material with an arc shape to be adapted to the curved user body shape, this feature allows to hold the loaded container next to the vertical axis body of the user.

The superior border of the container is a curved lip, so this curved border acts like a straightening rib.

The vertical internal wall of the curved container has a central area which shape is suited to engage with the frontal modulus of the belt, while the extreme superior vertices presents a handling hole disposed in the bottom area of the border lip, where the user can dispose their fingers and hold the container on. In an alternative embodiment, those handlings are formed by a pair of depressions disposed in the bottom wall of the container.

Said frontal wall of the container presents a vertical concave depression in the central area and it is destined to be used like another handling to manipulate the container.

While the bottom wall of the container, presents two straight and radial depressions with a semi cylindrical cross section and are destined to engage the container with the supporting “L” levers.

The container has a tall dimension related to the comfort of the user movements, allowing the user to be down folding their legs without touch the container, and at the same time, the container volume capacity is limited to a discrete capacity to load with bunches, so the user cannot overweight the container to cause column damage or bunches damage.

The elastic features of the pockets material, acts like a nonskid element and ensure the engage of the curved container to the frontal wall of the modulus.

In operative state, the system operates as is described in the next paragraphs: In a first instance the laborer should dress the belt up, around his waist with the cushioned members disposed in the waist back area and closing it in the frontal area by the closing means disposed in the frontal modulus, optionally the laborer can adjust the perimeter length of the belt by the Velcro patches disposed in the free extremes of it.

When the belt is fixed to the laborer waist, both “L” shape levers has to be spread out simultaneously till a final position, so the belt cause the constraint effect in the user waist, and more specifically in the user lumbar area, while said spread levers are disposed to receive the curved container in it.

The laborer take the scissors out of the accessories pockets and start to cut out the grapes bunches to deposit it inside the curved container. Once the container is full of bunches, the laborer keep the scissors inside the accessories pockets and carry the load on till the storing area. To pouring the harvest out of the container, the laborer thrown the container upward by the handling holes causing disengage the container from the “L” shape levers supports.

Usually the laborer receives some coins in exchange for the full container, which can be stored in another accessories pocket of the frontal modulus.

Further features, aspects and advantages of the present invention will become more apparent from the following description of the preferred embodiment and accompanying drawings, in which:

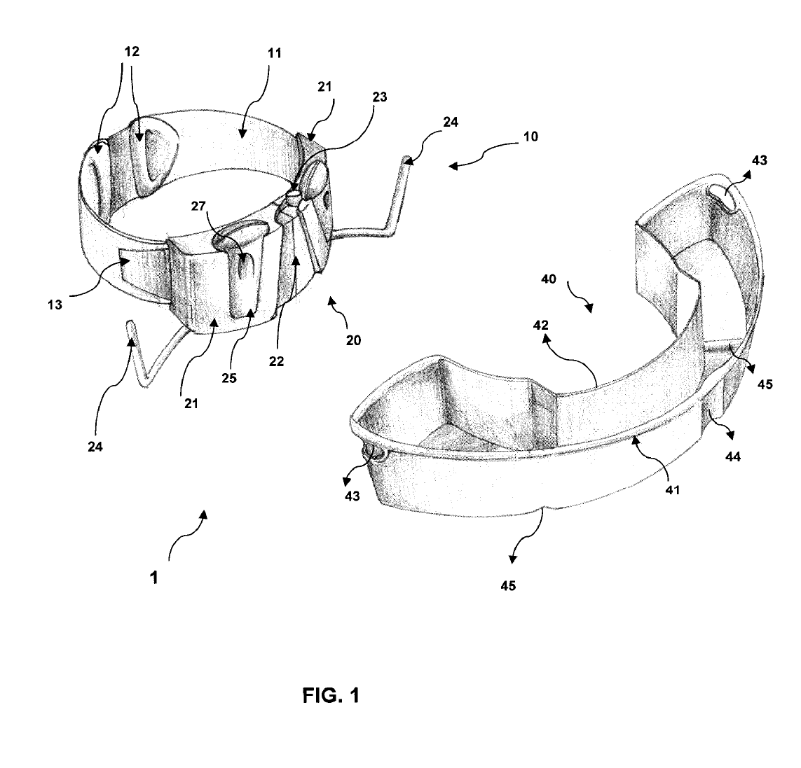

FIG. 1 is a perspective view of the invention in a disengage state.

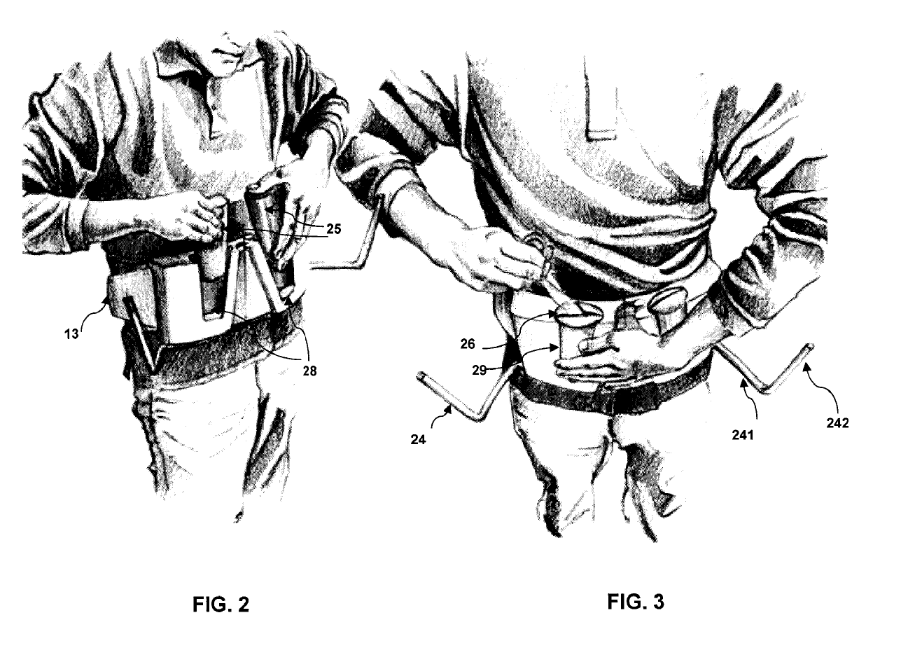

FIG. 2 is a perspective view of the invention showing the accessories pockets.

FIG. 3 is a perspective view of the invention in use.

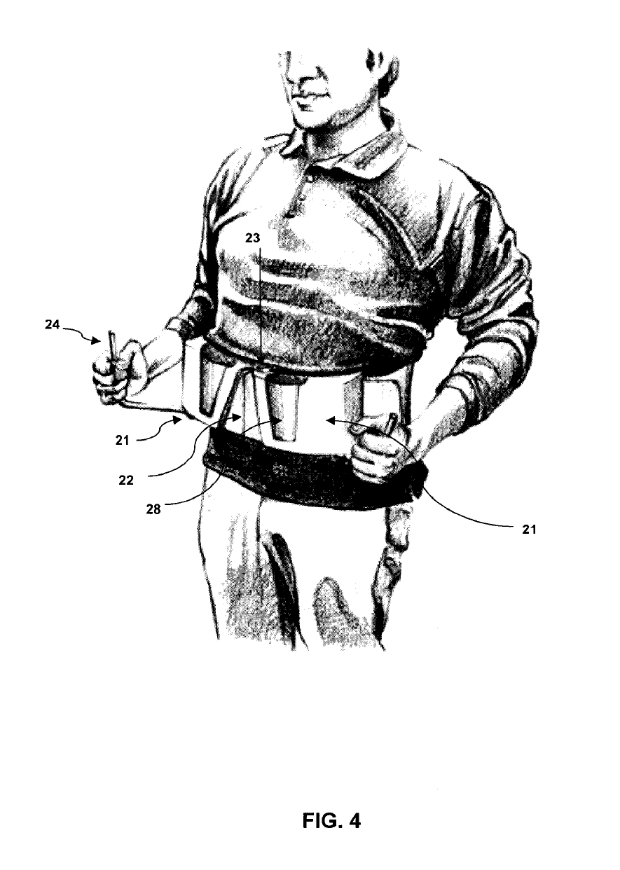

FIG. 4 is a perspective view of the invention in use, showing the “L” shape levers.

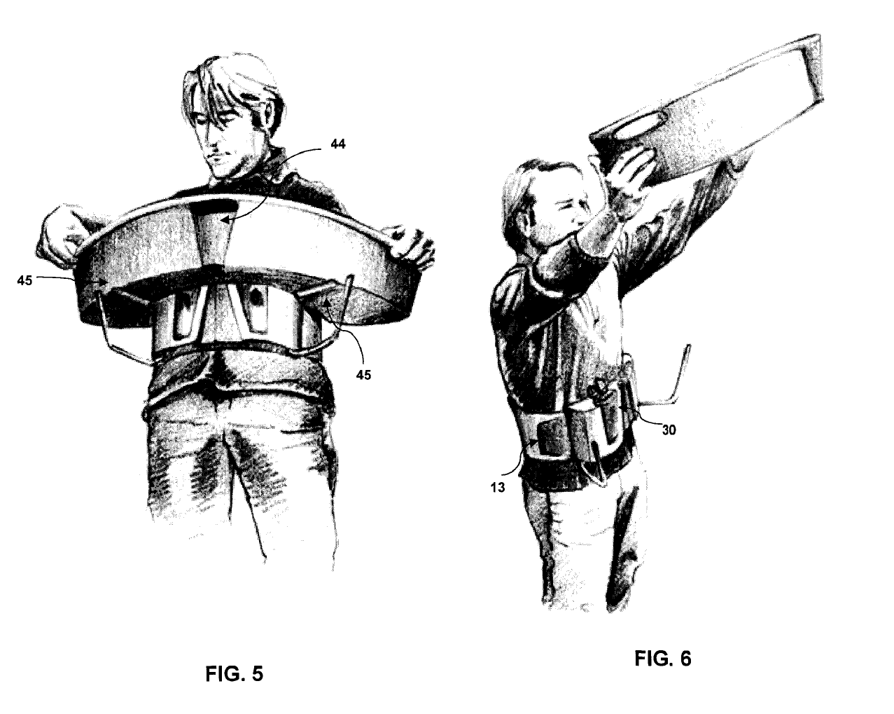

FIG. 5 is a perspective view of the invention in use, showing the container engage to the levers.

FIG. 6 is a perspective view of the invention in a disengage state.

### DETAILED DESCRIPTION OF THE INVENTION

Referring the drawings the manual harvesting equipment (1) of the invention includes a constrictor lumbar belt (10) surrounding the laborer abdomen perimeter and lumbar back area; a frontal modular piece (20) constructed in a rigid material which has several functions and an arc shape container (40) to deposits the cut grape bunches.

The constriction lumbar belt (10) consists in a flexible member (11) made of an elastic and cushioned material, preferably woven low elasticity Nylon, which it wraps around the body contour in the lumbar area of the user. Said constriction belt is provided with a pair of rigid cushioned members (12) disposed one to each side of the user's column.

Said cushioned members (12) are provided with an internal and straightening rib slightly flexible, disposed in the core. This piece allows an improved straightness of the user's lumbar area, especially when the user exerts the mayor force in their work.

The constriction belt (11) has an irregular shape, presenting a greater width in the back area of the belt, decreasing its width toward the lateral areas of the belt to facilitate the user's lateral body flexions.

Both ends (13) of the belt are free but are adjustable, and are provided with removable fastening means, like Velcro patches.

Said Velcro patches, allows the adjustable perimeter length once the belt ends has been passing through a passing groove present in the modular frontal piece (20).

The frontal modular piece (20) is constructed in a rigid material and formed by two independent modulus (21) with a curve shape, both. Said curve shape responds to an adaptation to the rounded shape of the laborer's body. The modulus piece is a multifunctional piece, so it has closing means for the constrictor belt, a length adjust mean for the constrictor belt, means for tight the belt around the laborer's body, store means for accessories and support means for the curve container.

Said closing means consists of a mechanical tie closure (22) (not showed in figures) with automatic release means activated by a pushing button (23); in a preferred embodiment, said close mean consist of one or more grooved stems rising in a lateral face of one of the modular piece which are faced to a circular perforation presented in the opposite modulus, said perforations are temporarily covered by a cylindrical retractile piece, which is connected to a base coil and at the same time said cylindrical piece is activated by said pushing button (23).

In operation, said push button moves down the cylinder uncovering the circular perforations to allow the stem entrance, so said grooved stems are trapped in the perforation by the retractile cylinder.

Said length adjust mean for the constrictor belt consists in a channel disposed in each modulus (21) and connected to a interior axis, so the belt enter and exit through said channel resulting engaged around said axis. When the free end (13) of the belt exits the channel, this extreme could be adhered to itself by Velcro patch permitting the belt adjust length to the user perimeter body.

Said belt constriction mean is a mechanism formed by two external levers (24) with “L” shape, attached to the modulus (21) by the horizontal stem of the “L” shape element (241), while the vertical stem (242) is disposed relative to the horizontal stem in a angle superior than 90° degrees.

Said levers (24) acts in two functional positions: the first one in an inoperative situation, rests folded over the modulus (20) and the second one in an operative situation, unfolded toward to an exterior position. Said levers are attached in the modulus interior to said internal axis, which axis has an eccentric position where the belt is wrapped around to engage it before exits from the modulus and then to fix to itself by the Velcro patch.

The movement mechanism of the “L” levers is activated ones a time the constriction belt (11) has been closed and the free ends (13) of the belt has been fixed to it self, and it consists in a hand operation unfolding from the first position to the second one. This unfolding movement, actives internally the eccentric axis to a closer position between both axis, so thrown the belt engaged around it causing a contrite of the belt around the body's perimeter.

The accessories store means of the frontal modulus (21) consists of pockets partially closed (25), constructed with a flexible material, like rubber, with a conical inverted shape and a elliptic cross section, which superior face is opened by a slot 826). These flexible pockets are destined to contain accessories like scissors or coins. In an alternative embodiment, the frontal wall of the pocket (25) presents a little depression (27) to fingers engage and thrown up the pocket (25) from the modulus (21).

Said pockets (25) are independent from the frontal modulus, but are retained in it, specifically inside a cavity (28) disposed in each modulus (21), which said cavities are suited to receive the pockets by a conical shape homologous with the conical pocket shape. And to facilitate the pocket grip from the cavities, these cavities show a frontal groove (29) where a few part of the pockets are exposed.

The support means of the curved container (40) consist of the same “L” shaped levers (24) disclosed before, so when they are in an operative spread position they are used like support arms to receive the curved container.

The inferior flag of the “L” lever (241) has a length related to the width of the base wall of the curved container, while the vertical flag high of the “L” lever (242) is related to the vertical walls of the curved container.

The grape bunches curved container (40) is a vessel opened to the top, made of a polymeric material with an arc shape to be adapted to the curved user body shape, this feature allows to hold the loaded container next to the vertical axis body of the user.

The superior border (41) of the container is a curved lip, so this curved border acts like a straightening rib, while the vertical internal wall of the curved container has a central area which shape is suited to engage with the frontal modulus of the belt, while the extreme superior vertices presents a handling hole (43) disposed in the bottom area of the border lip (41), where the user can dispose their fingers and hold the container on. In an alternative embodiment, those handlings are formed by a pair of depressions disposed in the bottom wall of the container.

Said frontal wall of the container presents a vertical concave depression (44) in the central area and it is destined to be used like another handling to manipulate the container and acts like a straightening rib of the frontal container wall.

While the bottom wall of the container (40), presents two straight and radial depressions (45) with a semi cylindrical cross section and are destined to engage the container with the supporting “L” levers.

While I have shown and describe the preferred embodiment of the invention, it will be understood that the invention may be embodied otherwise than as herein specifically illustrated or described and that certain changes inform and arrangement of parts and the specific manner of practicing the invention may be made with the underlying idea or principles of the invention.

It is to be understood that, although prior art use and publications may be referred to herein, such reference does not constitute an admission that any of these form a part of the common general knowledge in the art, in Australia or any other country.

For the purposes of this specification it will be clearly understood that the word “comprising” means “including but not limited to”, and that the word “comprises” has a corresponding meaning.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

1. Manual grape harvesting system for fine wines production, which improve the laborers conditions avoiding the lumbar lesions and possible accidents caused by working tools, the system comprising: a) a constriction lumbar belt with length adapting means and lumbar straightening means; b) a frontal modular piece with closing means, accessories store means and adjust belt means to constraint the laborer lumbar back area; c) a curved container to store the grape bunches, temporally fixed to the frontal modular piece through said belt adjust means.

2. Manual grape harvesting system according to claim 1 which the constriction lumbar belt has free ends and is made of elastic and foamed material, shows a symmetrical shape with a mayor width in the central area which is decreasing to said free ends of the belt.

3. Manual grape harvesting system according to claim 1 which said length adapting means consist of Velcro patches disposed in said free ends of the belt.

4. Manual grape harvesting system according to claim 1 which lumbar straightening means of the belt consists in a pair of cushioned members, disposed separately one each other and fixed to the belt central area, said cushioned members have an interior straightening rib.

5. Manual grape harvesting system according to claim 1 which frontal modular piece comprising two identical modulus made of rigid material formed in a curved shape;
said frontal modulus shows a lateral slot wherein the free belt ends passing through and it contains an interior mechanism with an eccentric axis to wrap said belt around before exit outside from said frontal modulus.

6. Manual grape harvesting system according to claim 1 which said closing means of the frontal modular piece consists in a mechanical tie closure with automatic release means activated by a push button.

7. Manual grape harvesting system according to claim 1 which said adjust belt means consists in a mechanism formed by two external levers with “L” shape, attached to the modulus by the horizontal stem of the “L” shape element, while the vertical stem is disposed relative to the horizontal stem in a angle superior than 90° degrees, whereas said horizontal stem is attached to said eccentric axis.

8. Manual grape harvesting system according to claim 1 which said accessories store means comprising two pockets made of elastic material and two cavities disposed in the frontal modulus.

9. Manual grape harvesting system according to claim 8 which said pockets have an inverted conical shape, with an elliptic cross section and a superior slot disposed in its top face.

10. Manual grape harvesting system according to claim 8 which said pockets have a little depression in their frontal face.

11. Manual grape harvesting system according to claim 8 which said cavities to receive said pockets have an inverted conic shape with elliptical cross section and a frontal vertical groove.

12. Manual grape harvesting system according to claim 1 which said container presents an arc shape, opened at the top face, bottom face with an arc shape and vertical lateral walls.

13. Manual grape harvesting system according to claim 12 which said container has a pair of handling hole disposed in both superior frontal vertexes.

14. Manual grape harvesting system according to claim 1 which said container rear wall presents a central depression with a shape coinciding with the frontal modular piece.

15. Manual grape harvesting system according to claim 12 which said container arc shape bottom wall has two radial depressions with semi cylindrical cross section.

16. Manual grape harvesting system according to claim 12 which said container frontal curved wall has a vertical depression in its central area with semi cylindrical cross section.
